(19) United States
(12) Patent Application Publication
(10) Pub. No.: US 2020/0115286 A1
(43) Pub. Date: Apr. 16, 2020

(54) THERMAL MATERIAL WITH HIGH CAPACITY AND HIGH CONDUCTIVITY, METHOD FOR PREPARING SAME AND THE COMPONENTS THAT COMPRISE SAME

(71) Applicants: CENTRE NATIONAL DE LA RECHERCHE SCIENTIFIQUE, Paris (FR); THALES, Courbevoie (FR); NANYANG TECHNOLOGICAL UNIVERSITY, Singapore (SG); UNIVERSITE DE LILLE, Lille (FR)

(72) Inventors: Matthieu PAWLIK, Singapore (SG); Hang Tong Edwin TEO, Singapore (SG); Jêrôme FONCIN, ELANCOURT CEDEX (FR); Thomas MERLET, ELANCOURT CEDEX (FR); Philippe COQUET, Singapore (SG); Manuela LOEBLEIN, Singapore (SG); Tony Siu Hon TSANG, Singapore (SG)

(21) Appl. No.: 16/612,701

(22) PCT Filed: May 16, 2018
(86) PCT No.: PCT/EP2018/062780

§ 371 Date: Nov. 11, 2019

(30) Foreign Application Priority Data
May 16, 2017 (FR) 17 00516

(51) Int. Cl. C04B 35/583; C04B 35/632; C04B 41/00; C04B 41/82; C04B 41/47; C04B 41/45

(52) U.S. Cl. CPC C04B 35/583; C04B 35/632; C04B 41/009; C04B 2103/0071; C04B 41/478; C04B 41/4572; C04B 41/82

(57) ABSTRACT

The present invention relates to a boron nitride (BN(C)) composite material in the form of a continuous structure, and a phase change material (PCM) included inside said continuous structure of (BN(C)), the method for manufacturing same and the components that comprise same.

The present invention concerns thermal management, in particular for technologies which require limited temperature rise, for example temperature regulation of electronic components. For the latter, it is sought efficiently to limit the increase in temperature of components during use thereof under transient operation, whilst taking up minimum space and having reduced weight without short-circuiting circuits.

With the increasing compactness of electronics, the issue of thermal management has become ever more crucial. The miniaturisation of electronics requires thermal management techniques to be compact and of low-cost in terms of energy. The issue is therefore to find means for limiting the rise in temperature of components when in use to guarantee optimal functioning, and also to obtain efficient storage and release of heat particularly in confined spaces. The latter without damaging the components, by limiting the end weight thereof and guaranteeing minimum bulk.

The most widespread solution for cooling is the use of a solid metal heat sink which is generally bulky however and of non-negligible weight relative to the electronics. In addition, it has limited capacity to evacuate heat.

Therefore, to facilitate the evacuation of heat, thermal interface materials are used to reduce all thermal contact resistance between the heat source and the sink. These materials are generally pastes or glues, which provide excellent component conformity. However, they do not allow the storage of heat.

Finally, another solution is to use phase change materials (PCMs) allowing the absorbing and storage of heat during the period of use. These materials are able to store surrounding heat by means of their high enthalpy of fusion (typically about 210 J/g), and on absorbing heat they limit the rise in temperature of their environment. PCMs are passive components but they have low thermal conductivity (0.15-0.25 W/mK), and their rigidity generates high thermal contact heat resistance limiting their capacity to absorb heat.

The first point can be improved by incorporating a material having strong thermal conductivity.

Initial studies endeavouring to improve the thermal conductivity of PCMs were conducted in the 1980s. Since then, several strategies have been developed in an attempt to increase the thermal conductivity thereof without modifying their heat storage properties. LJi et al. Energy Environ. Sci., vol. 7, no. 3, pp. 1185-1192, 2014 report the different ways of improving the conductivity of PCMs.

Two strategies are employed to improve the thermal conductivity of PCMs. The addition of conducting additives such as carbon nanotubes, graphene sheets, carbon fibres allows an improvement in thermal conductivity with a gain, in relation to the volume fraction of additive, of less than 2. Better continuity in conductive materials allows this gain to be improved. The first studies conducted with metal foams demonstrated this advantage (Aluminium, Carbon, Nickel). But here again, only a maximum gain of 6 was able to be ascertained.

However, graphite, and metal foams are also excellent electrical conductors which does not allow direct application to electronic components: the use of these materials on electrical components for thermal management would risk short-circuiting the systems. There is therefore a need to develop an alternative composite material containing a PCM and an additive having high thermal conductivity, but which also allows modulation of its electrical conductivity by making the composite partly conductive or partly isolating.

Boron nitride (BN) in powder form has been proposed to improve the thermal properties of PCMs. BN is an excellent electrical insulator whilst being an excellent thermal conductor. When it is mixed with a PCM, the thermal conductivity of the PCM is increased and hence its storage capacity, whilst guaranteeing electrical isolation of the components. It is also possible to dope this BN with carbon (BN(C)) to make it slightly electrically conductive.

BN is capable of competing with the thermal properties of graphene, whilst additionally having very high electrical resistance. In 2D form, BN is a chemically inert material with perfect thermal stability up to 1000° C. Its thermal conductivity, although theoretically lower than that of graphene, remains very high (in theory in the region of 2000 W/mK), compared with copper (400 W/mK) that is conventionally used.

For example, Jeong et al (Int. J. Heat Mass Transf., vol. 71, pp. 245-250, 2014) described the filling of PCM with BN powder in a proportion of 80% PCM, hence a BN fraction of 20%. A gain in thermal conductivity of 477% compared with the thermal conductivity of the PCM is described, which therefore corresponds to a gain per volume fraction of BN of only 0.24.

Carbon-doped BN foam (BN(C)) is known (Loeblein et al., Small, vol. 10, 15, 2992-2999, 2014) and has also exhibited high thermal conductivity compared with BN alone. It therefore remains to provide an improved composite allowing an increased gain in thermal conductivity.

Therefore, according to the invention, there is proposed a composite material comprising:
Boron nitride (BN(C)) in the form of a continuous structure; and
A phase change material (PCM) incorporated in said continuous BN(C) structure,
   said composite material having at least one face,
   and characterized in that said composite material, underneath all or part of said face, comprises a surface portion formed of the continuous BN(C) structure free of PCM.

The composite material of the invention containing a PCM and a continuous, optionally carbon-doped BN structure, is such that the PCM is incorporated in the interstices e.g. the pores of said continuous structure, and is characterized in that said composite underneath at least one face comprises a portion of nonzero thickness E free of PCM. The material therefore has at least one layer free of PCM underneath all or part of one of its faces.

The «BN(C) continuous structure» refers to any porous material composed of BN of continuous 3D structure, non-dispersed, optionally carbon-doped: it is then termed herein a BNC. As continuous structure, particular mention can be made of foams, grids, particularly foams.

BN(C) foams and their method of manufacture are described by Loeblein et al, Small, vol. 10, 15, 2992-2999, 2014.

Typically, the BN(C) foam can be produced by CVD growth on a copper or nickel metal template. After growth of the BN(C), the foam is coated with a polymer such as PMMA to guarantee the stability thereof, and it is then immersed in an acid bath to remove the metal template. The BN foam alone is obtained by etching the polymer.

The BN(C) foam can be reinforced for example by conducting lengthy growth, or several growths to increase the thickness of the BN(C) or by maintaining the PMMA on the foam (the PMMA thickness being sufficiently thin to maintain the desired thermal conductivity, PMMA having low thermal conductivity of 0.2 W/mK), and/or by adding additives to increase thermal conductivity.

In general, the continuous BN(C) structure may comprise between 5 and 80 weight % of carbon. This percentage is dependent upon envisaged applications. In particular, the carbon content can be modulated uniformly or locally to vary the electrical properties, for example by increasing electrical conductivity over the entire structure or on some areas, in applications such as electromagnetic protection of electronic components.

In one embodiment, the continuous BN(C) structure has a density of between 1 and 5 mg/cm³, and porosity of between 5 and 120 pores per inch.

The thermal conductivity of the continuous structure is generally higher than the thermal conductivity of the PCM.

By the term «face» designated herein it is meant an outer surface of the composite material.

The «surface portion» or «portion» corresponds to at least one part of the face intended to be in contact with the electronics when the composite material is applied to a component. Said portion may correspond to all or part of the face of the composite, on the understanding that the portion comprises that part of the face underneath which it is located together with the thickness layer E immediately located underneath this part of the face. In this portion, the continuous structure is free of PCM.

The composite material therefore comprises at least one surface portion of thickness E underneath all or part of the face, such that within said portion the continuous structure is free of PCM.

In a first embodiment, said material comprises a lower face and an upper face and underneath each of the two faces at least one surface portion of continuous structure free of PCM, and therefore having a layer of PCM+BN(C) sandwiched between two layers of BN(C) free of PCM. In other words, a layer of BN(C) free of PCM is present underneath each lower and upper face.

In a second embodiment, said material comprises a lower face, an upper face and at least one side face, and underneath each of these faces it has a surface portion of continuous BN(C) structure free of PCM, therefore having an inner volume of PCM+BN(C) surrounded on all the faces by a BN(C) layer free of PCM. In other words, a layer of BN(C) free of PCM is present underneath the lower, upper and side faces.

For a given composite material, the thickness of the BN(C) portions free of PCM can be the same or different for each face.

In general, the thickness of said portion is substantially narrower than the thickness of the composite. Typically, the thickness E can be adapted as a function of the roughness of the material onto which the composite material is to be applied. In general, it has a thickness at least equal to the diameter of a pore of the continuous structure. The thickness E must be sufficient to minimise contact resistance and provide necessary thermal conduction. The thickness of the whole structure is generally limited on account of weight and bulk restrictions of electrical components. For example, mention can be made of a thickness E greater than 250 μm, in particular for a highly porous continuous structure.

The thickness E can be controlled with the method for producing the composite material.

The portion of continuous structure free of PCM is therefore composed of a continuous BN(C) structure which ensures good contact with electronics thereby guaranteeing good thermal conduction from the circuit towards the composite, whilst controlling the electrical impact of the composite on the remainder of the circuit.

Since the continuous structure such as BN(C) foam is flexible, it can adapt to the surface roughness of the electronic component and reduce the presence of air pockets, thereby reducing thermal contact resistance. It can also withstand phase changes of the PCM which generally has an expansion phase of 10 to 15%.

In addition, the continuous structure such as the BN(C) foam has the advantage of being extremely low-density, meaning that the storage capacity of the PCM at constant weight can be maintained. BN(C) is a chemically inert material and therefore provides passivation/protection of electronic components vis-a-vis the environment. This allows direct application of the compound onto electronics, and improved heat absorption.

By PCM it is meant any material capable of undergoing phase transition at a temperature (or restricted temperature range) and of storing and optionally releasing energy during this transition. At the transition phase, the temperature of the PCM remains constant. In general, PCMs suitable for the invention involve solid/solid phase or solid/liquid phase transition.

To ensure optimal heat storage, they typically have a latent heat of fusion of at least 50 J/g.

In one embodiment, PCMs can be selected from among PCMs of organic, organometallic, inorganic or eutectic polymer type.

As PCM, particular mention can be made of PCMs selected from among PCMs marketed by RUBITHERM, Polywax polyethylene (marketed by Baker Hughes), Puretemp (marketed by Puretemp), paraffin, erythritol.

The choice of PCM is dependent upon the maximum permitted temperature for the use under consideration. Typically, a PCM is chosen having a phase transition temperature equal to or lower than the maximum permitted temperature.

The composite material of the invention therefore has the following advantages:
very good conformability with the surface to be thermally regulated;
versatility: the phase change temperature can be modulated between 50 and 200° C., by modifying the PCM;
easily high thermal storage capacity;
improved thermal conductivity compared with that of the PCM (the gain in relation to the volume fraction of BN(C) can reach 10);
electrical isolation with global and spatial adaptability so as not to perturb electronic systems;
chemically inert and stable not emitting gas under normal operating conditions, thereby preventing any reaction with the environment;
low density, thereby limiting the weight of the system;
low thermal contact resistance, ensuring good heat absorption of the electrical component.

A further subject of the invention concerns a method for preparing said composite material.

In the invention, the method comprises infusing the PCM in liquid form into the continuous BN(C) structure, and protection/deprotection of the surface portions(s) and/or removal of PCM from the surface portion(s).

In a first embodiment, said method comprises the following steps:
Prior protection of said surface portion underneath at least one lower face and/or upper face of the continuous BN(C) structure;
Impregnation of the continuous BN(C) structure with a PCM in liquid form;
Selective deprotection of the protected surface portion;
resulting in a continuous BN(C) structure in which the PCM is incorporated, with the exception of at least one surface portion free of PCM.

Protection can be obtained by impregnating a protective material in the thickness of said surface portion.

This impregnation can be obtained using any method allowing application of a liquid material to the surface and in the thickness of a matrix. The application method is dependent on the type and viscosity of the material, and the matrix.

In one embodiment, impregnation is obtained by hot infusion. Infusion can be performed by deposit or immersion of the surface portion of the continuous BN(C) structure to be protected on or in a solution of protective material.

In general, this impregnation is conducted at a temperature higher than the melting temperature of the protective material so that it is in liquid form with viscosity adapted to the desired thickness.

The protective material is selected so that it is able to be:
impregnated in the liquid state,
held in the solid state when impregnating with the PCM in the liquid state, and/or
selectively deprotected in the formed composite.

In one embodiment, the protective material has a melting temperature higher than that of the PCM.

Typically, the protective material is a polymer, optionally diluted in a solvent to adjust the viscosity of the protective material to the type of continuous BN(C) structure and the desired thickness.

In one embodiment, the protective material can be selected in particular from among polyethylene oxide (PEO) with water or isopropanol (IPA) as solvent, polyvinylidene fluoride (PVDF) with dimethylacetamide (DMA) or N,N-dimethylformamide (DMF) as solvent, neopentyl glycol (NPG) with water as solvent.

In one embodiment, PEO is used as protective material, diluted in water, at a dilution rate of between 10 and 50%, in particular between 20 and 25%.

PEO is a very common polymer which does not raise any particular problem in terms of handling and storage. Its solvent is water which has the advantage of being low-cost and again having easy handling and storage.

The protective material can be degassed prior to use, to eliminate air bubbles and hence allow better impregnation.

If protection is obtained with a protective material in the liquid state, the method comprises the intermediate step of fixing the protective material on the continuous structure by increasing the viscosity of the protective material e.g. by evaporating the solvent.

The protection step can be performed as many times as necessary as a function of the number of surface portions to be protected, before the impregnation step with the PCM.

Impregnation of the continuous BN(C) structure with the PCM can be performed with a liquid PCM after protecting the surface portion(s) to be protected.

The impregnation step is performed at a temperature higher than the melting temperature of the PCM.

Typically, the protective material must have either a higher melting temperature than the melting temperature of the PCM or, if the protective material has a lower melting temperature, it must have a melt time when immersed in the liquid PCM that is much longer than the infusion time of the PCM in the non-protected continuous structure. Also, typically, the protective material must not be chemically attacked by the PCM in liquid form.

If needed, it is possible to cool the surface portions locally with the protective material during impregnation with the PCM.

Impregnation with the PCM can be performed by immersing the entire protected continuous structure in a PCM solution.

Deprotection can be particularly obtained by selective degradation of the protective material, for example via chemical route, typically by action of a deprotection solvent in which the protective material is soluble. This can be carried out by immersing the entire protected continuous structure in a bath of the solvent under consideration.

As deprotection solvent, mention can be made of the solvents of the above-cited protective materials.

In general, the method further comprises the intermediate step to fix the PCM on the continuous structure, by reducing the temperature to cause the PCM to change to the solid state, prior to the deprotection step. This step can be conducted in moulds of varied shapes to adapt to packaging and the application.

This alternative of the method of the invention advantageously allows a composite of «sandwich» type to be prepared, having portions of BN(C) free of PCM on two of its opposite-lying faces, as described above in a first embodiment.

In a second embodiment, the method comprises the removal of PCM impregnated in the BN(C) structure from the surface portion(s).

Unlike in the first method, this embodiment does not require a protection step of said surface portion.

Therefore, the method in the second embodiment comprises the following steps:
Impregnation of the continuous BN(C) structure (1) with a PCM (5) in liquid form;
Selective etching of the PCM in one or more surface portions.

Such as used herein, the term «etching» designates chemical etching, which can be performed by immersion in an etch solvent bath. The etch solvent is a solvent allowing dissolution of the PCM but not damaging the continuous BN(C) structure when etching. For example, as etch solvent mention can be made of ethanol, isopropanol (IPA), acetone, Ie toluene, xylene, vegetable oil.

The temperature of the etch solution provides control over etching rate. The higher the temperature the faster the etching rate. The bath generally contains sufficient solvent to prevent saturation of the solvent with PCM and thereby avoid PCM re-deposits.

Etching is typically conducted at a temperature lower than the boiling point of the bath and also lower than the melting point of the PCM, to prevent liquefaction of the PCM.

Typically, if ethanol is used with a PCM having a melting point of 90° C., the etching temperature lies between 50 and 80° C. depending on desired etch rate.

Etching can be halted by withdrawing the composite from the etching bath.

After etching, a rinse step can be performed generally by immersing the composite in one or more ethanol baths at the same temperature as the etching bath.

This can be followed by drying e.g. over a hot plate or in an oven at a temperature lower than the melting point of the PCM.

This alternative of the method of the invention advantageously allows the preparation of a composite having portions free of PCM underneath all its faces.

In a third embodiment, the method combines at least one protection step and at least one PCM etching step. With this embodiment, it is possible to obtain surface portions of different thicknesses.

The method then comprises the following steps:
Prior protection of at least one surface portion (1′) of the continuous BN(C) structure (1) with a protective material having an etch rate differing from that of the PCM;
Impregnation of the continuous BN(C) structure (1) with a PCM (5) in liquid form;
Etching the PCM and the protective material by immersion of the material in an etching solvent.

Etching anisotropy can be controlled by using a protective material having an etch rate differing from that of the PCM for the chemical etching bath employed. For example, prior to the infusion step of the PCM in the continuous BN(C) structure, a surface portion of the continuous BN(C) structure can be infused with a protective material, typically NPG in the liquid state, at a temperature higher than the melting temperature of the PCM. After solidification of the NPG, the PCM is infused in the liquid state at a temperature of between the melting temperature of the PCM and that of NPG. The composite is then etched with the etching solution. Since the etch rate of the protective material differs from that of the PCM, the resulting surface portion free of PCM will have a different thickness depending on whether the portion was impregnated with protective material or PCM. If needed, the portion(s) still containing protective material can be deprotected as explained above.

Advantageously, the PCM etching solvent also allows deprotection/etching of the protective material.

For example, for an ethanol bath at 60° C., etching of NPG is almost instantaneous whereas that of the PCM is approximately 10 μm per minute. The entire area that has been infused with NPG, which may cover several millimetres, is then released without the non-protected areas having been significantly etched.

The material thus formed with this alternative has a continuous BN(C) structure in which the PCM (5) is incorporated, with the exception of said surface portion (1′) free of PCM and of the other surfaces on which the PCM has been etched, on the understanding that surface portions of different thicknesses can be obtained depending on whether or not said portions have been protected.

This second alternative of the method of the invention advantageously allows the preparation of a composite according to the second embodiment described above, having surface portions of BN(C) free of PCM underneath all its lower, upper and side faces, thereby delimiting an inner volume formed of BN(C) and of PCM.

The method of the invention may also previously comprise the preparation of the continuous BN(C) structure.

The BN(C) foam can be prepared by applying or adapting the methodology described by Loeblein et al., Small, vol. 10, n. 15, 2992-2999, 2014.

For example, the BN(C) foam can particularly be prepared by CVD growth (chemical vapour deposit) on a copper or nickel template for example. After growth of the BN(C), the foam is coated with a polymer such as PMMA to guarantee stability, then immersed in an acid bath to remove the metal template. The BN(C) foam is then obtained by removing the polymer or, in one variant, the PMMA can be at least partly maintained to increase the solidity of the foam.

The composite material thus formed can be applied to an electronic component.

The present invention therefore concerns an electronic component comprising a composite of the invention, in particular such that the composite is applied via the face free of PCM in contact with the component.

In general, the choice of PCM is such that the melting temperature of the PCM is equal to or lower than the maximum operating temperature of the component.

The BN(C) foam has high thermal conductivity and is flexible/conformable. On compressing, it fills all air holes and reduces thermal contact resistance. This allows improved heat transmission from the electronic component towards the PCM. In addition, the continuity of the foam allows the diffusing of this heat towards the PCM for storage thereof. Also, the variation in the amount of carbon in the BN(C) foam, globally or locally, means that it can be made compatible with the electronics onto which it is to be applied. This allows the PCM to be placed as close as possible to hot points.

A further subject of the invention also concerns the method for fabricating an electronic component comprising a composite of the invention.

This can be achieved with any usual method e.g. compression of the composite via encapsulation of the composite in aluminium for example or another non-metallic encapsulating material.

The invention and its advantages will be better understood on examining the following description given solely as an example and with reference to the appended drawings in which:

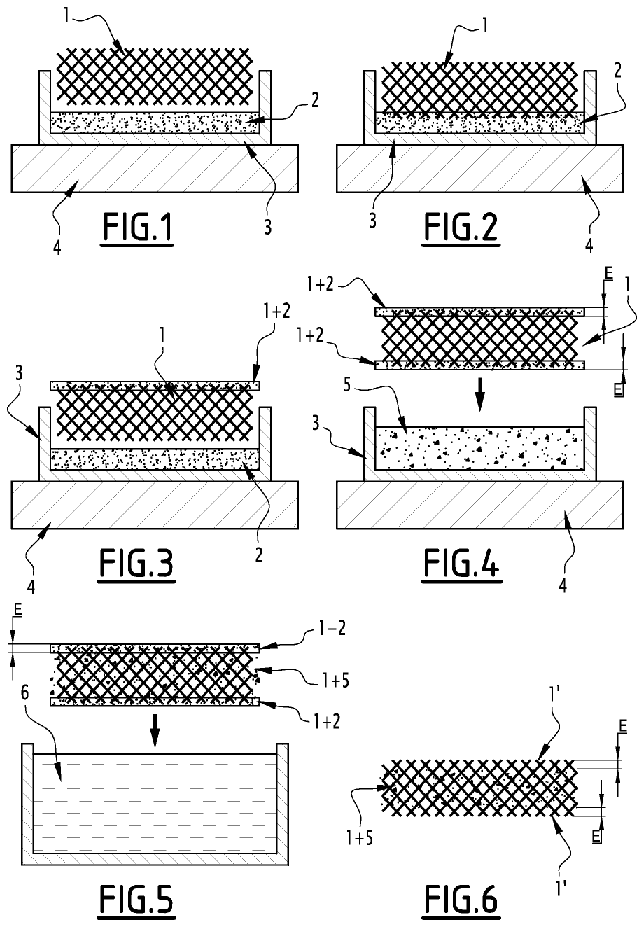

FIGS. 1 to 6 are diagrams illustrating the fabrication steps of a composite material of the invention according to the first embodiment;

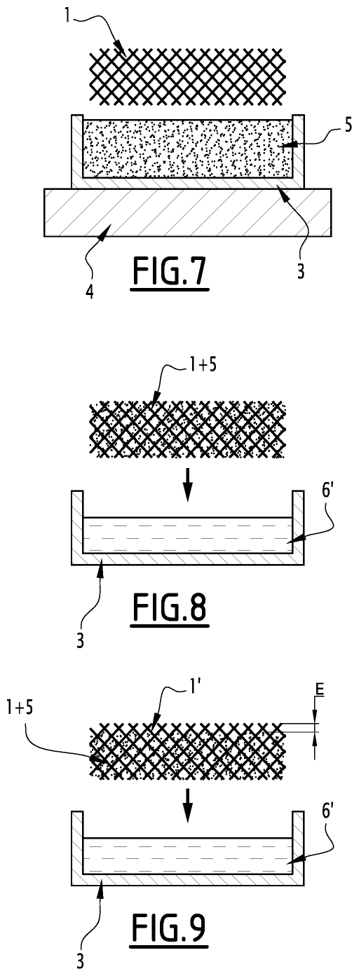

FIGS. 7 to 9 are diagrams illustrating the fabrication steps of a composite material of the invention according to the second embodiment; and

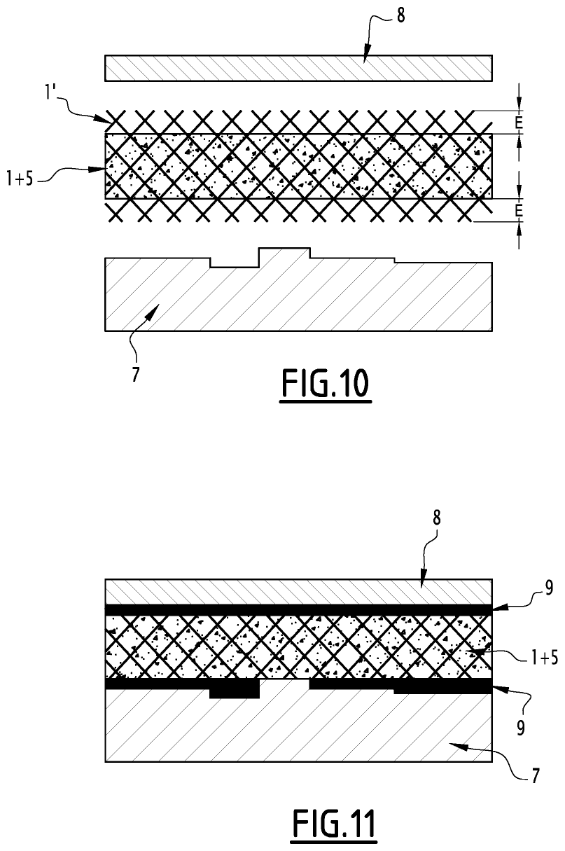

FIGS. 10 and 11 are diagrams illustrating the fabrication steps of an electronic component comprising a composite material of the invention.

As illustrated in FIGS. 1 to 6, in a first embodiment, the composite material of the invention can be prepared in several protection/deprotection steps detailed below.

The fabrication of the composite comprises forming of the BN(C) foam 1, followed by protection of surface portions 1′ of the foam 1 with a protective material 2 (FIGS. 1 to 3) to prevent the presence of PCM 5 on the surface, infusion of the PCM 5 in the foam 1 (FIG. 4) and finally removal of the protection 2 (FIG. 5) to free the surface portions 1′ of the foam.

More specifically, as illustrated in FIGS. 1 and 2, a protective material 2 such as a polymer in solution in a solvent is prepared to obtain the desired viscosity (which impacts the thickness E of the surface portion 1′ of the foam impregnated with said material 2) and to limit the presence of bubbles on solidification thereof. Bubbles would make the material 2 fragile in some areas and would allow the entry of liquid PCM 5. This viscosity is dependent on the polymer and level of dilution thereof in a solvent.

The prepared protective material 2 is placed in a container 3 (FIG. 1) and the BN(C) foam 1 is deposited on said material 2 (FIG. 2). The whole is heated over a hot plate 4 for example until the material 2 forms a thin layer on the surface of the foam 1. The thickness E of the protected surface portion 1′ can be controlled by means of the viscosity of the material 2.

Optionally, and as illustrated in FIG. 3, this operation can be conducted in the same manner on another face of the BN(C) foam.

As illustrated in FIG. 4, once each face is protected on which it is desired to preserve a PCM-free surface portion 1′, the PCM 5 is heated to change to the liquid state. The protected foam 1 is immersed in a bath of PCM 5. The PCM 5 is left to infuse only the core of the foam 2 and the foam thus impregnated is removed from the bath of PCM 5. The composite material obtained is left to cool so that the PCM 5 returns to the solid state. The shape of the mould for the PCM is arbitrarily shown to be square in the diagrams but can be modified to adapt to package and application restrictions.

Finally, as illustrated in FIG. 6, the composite material is immersed in a solvent bath 6 of the protective material 2, to solubilise the material 2 and thereby remove the material 2 from each surface portion 1′.

As illustrated in FIGS. 7 to 9, in the second embodiment of the method of the invention, the composite material of the invention can be prepared by selective etching of PCM.

Fabrication of the composite first comprises immersion of the continuous BN(C) structure in a bath of PCM 5 contained in a container 3 placed over a hot plate 4. Full immersion is performed as in the second embodiment (FIG. 7). The material is then removed from the bath: it is composed of the BN(C) structure impregnated over its entire thickness with PCM 5. The surface portions of the material thus obtained are immersed in a bath of etching solution 6′, allowing the PCM to be dissolved on the immersed portions. The lower and upper faces can be successively immersed to leave two lower and upper surface portions 1′ of BN(C) free of PCM. In a variant of this embodiment, the material can be fully immersed, which means that all the surface portions are freed of PCM underneath all the faces of the material.

A third embodiment can be illustrated by combining the steps of FIGS. 1-6 and FIGS. 7-9.

The composite material thus formed can then be applied to an electronic component. In one variant illustrated in FIG. 10, the composite material is encapsulated between an aluminium cover 8 and an electronic component 7 e.g. a processor.

The component 7 has irregular surface relief. By compression, the surface portions 1′ of the composite material fill the cavities and follow the contour of the roughness of the component 7.

Therefore, as illustrated in FIG. 11, the compressed surface portions 1′ form layers 9 of BN(C) which are in contact with the component 7 and with the cover 8. This ensures electrical isolation, passivation of the component and reduced thermal contact resistance.

The following examples give a nonlimiting illustration of the present invention.

### EXAMPLE 1: PREPARATION OF THE BN(C) FOAM

A BN foam was prepared by applying the methodology described by Loeblein et al., Small, vol. 10, n. 15, 2992-2999, 2014, without conducting the carbon growth step. PMMA was deposited just before etching the nickel for mechanical reinforcement of the BN. The PMMA can be removed or left in place after etching the nickel.

### EXAMPLE 2: PREPARATION OF THE COMPOSITE

Strategy

To obtain the BNC foam infused with PCM (Phase Change Material) solely in the centre and not on the surface, the first strategy is to use a material which will protect the surfaces of the foam during infusion. This protective material is later removed.

Protection of the Foam Faces

PEO (Polyethylene Oxide) was used as protective material. It is first diluted in water in proportions allowing a polymer to be obtained with suitable viscosity, here between 20 and 25% PEO.

At a second step, the diluted polymer is placed in a vacuum at about 2.5 mTorr for 30 min. The purpose of this «degassing» step is to remove the air bubbles trapped in the polymer when mixing. Without this step, during the densification phase air bubbles could form, damage the foam and jeopardise the uniformity of polymer thickness.

At a third step, the polymer is deposited in an aluminium mould. The amount of polymer will depend on the size of the mould to reach a polymer thickness of about 3 mm. The foam is deposited on the polymer and will slightly penetrate the latter. The depth of penetration will depend on the viscosity of the polymer. Finally, the mould is placed over a hot plate to densify the polymer by gradually evaporating the solvent (here water). It was experimentally shown that a step at 80° C. for 40 min followed by a rise of 5° C. every 5 min to reach 120° C. is favourable. However, said temperature and time are dependent on the temperature probe of the hot plate and the laboratory environment, since everything takes place in air.

At step four, the foam with one protected face is removed from the mould. One of the faces is perforated with a needle. The purpose of these perforations is to promote later PCM infusion and only scarcely damage the foam.

The fifth step is the same as the third but on the opposite face of the foam.

Infusion of PCM in the Protected Foam

Paraffin was used as PCM.

The paraffin was heated to 110° C., i.e. slightly above the melting point of paraffin of 90° C., in the aluminium mould. Once the paraffin has changed to liquid phase, the foam with the two protected faces is immersed therein: the paraffin filters through the sides but also through the perforated face which is held in the upper position. The foam is left for between 3 and 5 min in the PCM to ensure full infusion whilst preventing melting of the protective polymer. Finally, it is left to cool naturally or in a refrigerator to accelerate cooling.

Removal of the Protective Polymer

To remove the polymer, the protected foam is immersed in water at ambient temperature. The compound is maintained vertically (to avoid damaging the surfaces) in a beaker of water overnight. The water bath is renewed and left to act overnight a further time to improve deprotection as a function of the thickness of the polymer, the size of the sample and amount of water. Finally, the sample is left to dry.

### EXAMPLE 3: CHARACTERIZATIONS/PERFORMANCE OF THE COMPOSITE

Thermal Characterizations:
Measurement of the density of the end compound. To show that the foam only scarcely modifies the weight of the PCM alone.
Measurement of the latent heat of fusion of the compound. For the same reason, which is to show the low impact of the foam on the thermal storage capacity of the PCM. It is sought to maintain the latent heat of fusion of the PCM.
Measurement of thermal conductivity to show the advantage and contribution made by the foam.
Measurement of contact resistance to verify the capability of the compound to conform to surfaces.

Electrical Characterizations:
To evaluate the electrical conductance of the compound and confirm its isolating nature for pure BN(C) and slightly conductive for BNC. Similarly, for validation of the isolating or slightly conductive areas in the event of localized doping.
Radiofrequency measurements (losses, transmissions) to determine the impact of the presence of the compound in an electronic environment.

Physical Characterizations:
Thermal expansion coefficient of the compound for future package design.
Compressive and tensile mechanical strength.
Visualisation of the conformability of the foam released on the surface.

### EXAMPLE 4: PREPARATION OF THE COMPOSITE WITHOUT PROTECTIVE MATERIAL, BY ETCHING

For this method, the continuous BN(C) structure is first infused with PCM in liquid phase, at a temperature higher than the melting temperature of the PCM. The compound obtained is immersed in an ethanol bath at 65° C., allowing selective etching of the PCM in relation to the continuous structure. Each PCM face is etched at a rate of about 5 μm/min. One bath hour allows the release of about 300 μm of surface portion on each face of the compound. Thereafter, the compound is successively immersed in several ethanol baths at 65° C. for a few minutes to remove re-deposits of PCM on the surface portions. Finally, the compound is dried in an oven at 50° C. for 1 hour.

### EXAMPLE 5: PREPARATION OF THE COMPOSITE WITH PROTECTIVE MATERIAL AND BY ETCHING

This method combines the two preceding preparations so that it is possible to obtain surface portions of different thicknesses.

First, the continuous BN(C) structure is infused on the surface with liquid NPG over a hot plate at a temperature of about 130° C. Typically, the NPG infuses the continuous structure over a thickness of 1 to 2 mm. This step is repeated on the two opposite faces of the structure. The structure thus protected is immersed in the liquid PCM at 110° C. since its melting temperature is 90° C. in this Example. After infusion and solidification of the PCM, the compound is immersed in an ethanol bath at 65° C. The NPG dissolves almost instantly on the two protected faces releasing the surface portion over a thickness of 1 to 2 mm on these faces, the other faces being etched at a rate of about 5 μm/min. This makes it possible to obtain surface portions of different thicknesses.

### EXAMPLE 6: FABRICATION OF A COMPONENT COMPRISING THE COMPOSITE

The invention can be applied to a power transistor dissipating 20 W for example when in cyclic use, e.g. for continuous operation of less than 15 min, with a cooling time of 15 min. The PCM is chosen as a function of the maximum critical temperature of the transistor: the melting temperature of the PCM must be equal to or lower than the critical temperature of the transistor. The material of the invention is applied directly onto the transistor, with one of the PCM-free faces in contact with the transistor to ensure good thermal contact. The surround of the PCM is encapsulated as well as the base of the processor to ensure sealing.

1. Composite material comprising:
Boron nitride BN(C) in the form of a continuous structure; and
A phase change material (PCM) incorporated in said continuous BN(C) structure,
said composite material comprising at least one face;
and characterized in that said composite material, underneath all or part of said face, comprises a surface portion formed of the continuous BN(C) structure free PCM.

2. The composite material according to claim 1 such that said surface portion is a layer of nonzero thickness E underneath the entirety of said face.

3. The composite material according to claim 1, such that the continuous BN(C) structure is a BN(C) foam.

4. The composite material according to claim 1, such that the continuous BN(C) structure is a continuous BNC structure.

5. The composite material according to claim 1, such that said composite material comprises a lower face and an upper face, and such that underneath each of the two faces it comprises at least one surface, portion of the continuous structure free of PCM.

6. The composite material according to claim 1, such that the composite material comprises a lower face, an upper face and one or more side faces, such that a surface portion of the continuous BN(C) structure free of PCM is present underneath each of these faces.

7. Method for preparing a composite material according to claim 1, said method comprising:
infusion of the PCM in liquid form in the continuous BN(C) structure, and
protection/deprotection of the surface portion(s) and/or removal of any PCM infused in the surface portion(s).

8. The method according to claim 7 comprising following steps:
Prior protection of at least one surface portion of the continuous BN(C) structure by impregnating a protective material;
Impregnating the continuous BN(C) structure with a PCM in liquid form;
Selective deprotection of the protected portion(s);
Thereby forming a continuous BN(C) structure in which the PCM is incorporated, with the exception of the surface portion(s) free of PCM.

9. The method according to claim 8, such that impregnation with the PCM is conducted at a temperature higher than the melting temperature of the PCM, and is either lower than the melting temperature of the protective material or at a temperature generating a melting time of the protective material that is less than the infusion time of the PCM.

10. The method according to claim 8 such that said protective material has a melting temperature higher than the melting temperature of the PCM.

11. The method according to claim 7 comprising the following steps:
Impregnation of the continuous BN(C) structure with a PCM in form;
Selective etching of the PCM in at least one surface portion.

12. The method according to claim 7 comprising:
Prior protection of at least one surface portion of the continuous BN(C) structure with a protective material having an etch rate differing from that of the PCM;
Impregnation of the continuous BN(C) structure with a PCM in liquid form; and
Etching the PCM by immersing the surface area(s) impregnated with the material in an etching solvent.

13. Electronic component comprising a composite material according to claim 1.

14. Method for fabricating the component according to claim 13 comprising the step to apply the composite to the component.
